(19) United States
(12) Patent Application Publication
(10) Pub. No.: US 2014/0344763 A1
(43) Pub. Date: Nov. 20, 2014

(54) INFORMATION PROCESSING DEVICE, INFORMATION PROCESSING METHOD, AND PROGRAM

(71) Applicants: Kazuyuki Yamamoto, Kanagawa (JP); Masao Kondo, Tokyo (JP); Ikuo Yamano, Tokyo (JP)

(72) Inventors: Kazuyuki Yamamoto, Kanagawa (JP); Masao Kondo, Tokyo (JP); Ikuo Yamano, Tokyo (JP)

(73) Assignee: SONY CORPORATION, Minato-ku, Tokyo (JP)

(21) Appl. No.: 14/344,264

(22) PCT Filed: Jul. 25, 2012
(86) PCT No.: PCT/JP2012/068808

§ 371 Date: Mar. 11, 2014

(30) Foreign Application Priority Data
Oct. 5, 2011 (JP) 2011-220766

(51) Int. Cl. G06F 3/0484

(52) U.S. Cl. CPC G06F 3/0484
USPC 715/856

(57) ABSTRACT

Provided is an information processing device including a changing speed setting unit that sets a changing speed of an object displayed on a display unit, based on a weighting to an input operation unit capable of inputting operation information related to a changing direction of the object, and a display control unit that changes the object at the changing speed.

### TECHNICAL FIELD

The present disclosure relates to an information processing device, an information processing method, and a program.

### BACKGROUND ART

As disclosed in, for example, Patent Literature 1, there is known an information processing device that provides a graphical user interface, so-called GUI. Such an information processing device displays various objects on a display. A user inputs operation information by operating a mouse or a touch panel, and the information processing device changes an object based on the operation information. For example, the information processing device performs a scroll and an enlargement/reduction of an object.

### CITATION LIST

### Patent Literature

Patent Literature 1: JP 2011-13980A

Patent Literature 2: JP 2010-92071A

### SUMMARY OF INVENTION

### Technical Problem

However, the information processing device disclosed in Patent Literature 1 could not change the object in detail. On the other hand, Patent Literature 2 discloses a technology for generating a vibration when a user presses a touch panel. However, this technology is to merely generate a vibration and did not contribute to the change of the object at all. Therefore, there has been a need for technologies that can change an object in detail.

### Solution to Problem

According to the present disclosure, there is provided an information processing device including a changing speed setting unit that sets a changing speed of an object displayed on a display unit, based on a weighting to an input operation unit capable of inputting operation information related to a changing direction of the object, and a display control unit that changes the object at the changing speed.

According to the present disclosure, there is provided an information processing method including setting a changing speed of an object displayed on a display unit, based on a weighting to an input operation unit capable of inputting a changing direction of the object, and changing the object at the changing speed.

According to the present disclosure, there is provided a program for causing a computer to achieve: a changing speed setting function of setting a changing speed of an object displayed on a display unit, based on a weighting to an input operation unit capable of inputting a changing direction of the object, and a display control function of changing the object at the changing speed.

According to the present disclosure, the changing speed of the object is set based on a weighting to the input operation unit, and the object is changed at the changing speed. Therefore, the user can reflect the operation of pressing the input operation unit to the changing speed of the object, in addition to the operation of determining the changing direction.

### Advantageous Effects of Invention

According to the present disclosure, as described above, the user can reflect the operation of pressing the input operation unit to the changing speed of the object, in addition to the operation of determining the changing direction. Therefore, according to the present disclosure, it is possible to change the object in more detail.

### BRIEF DESCRIPTION OF DRAWINGS

FIG. 1(a) is a side view of a mouse (input operation unit) according to a first embodiment of the present disclosure. FIG. 1(b) is a side sectional view of the mouse. FIG. 1(c) is a plan sectional view of the mouse.

FIG. 2 is a block diagram illustrating a configuration of the mouse.

FIG. 3 is a block diagram illustrating a configuration of an information processing device.

FIG. 4 is an explanatory diagram illustrating an example of a moving amount determination graph the information processing device stores.

FIGS. 5(a) to 5(c) are explanatory diagrams illustrating another example of a moving amount determination graph.

FIG. 6 is an explanatory diagram illustrating an example of processing by the information processing device.

FIG. 7 is an explanatory diagram illustrating a display example by the information processing device.

FIG. 8 is an explanatory diagram illustrating a display example by the information processing device.

FIG. 9 is an explanatory diagram illustrating a display example by the information processing device.

FIG. 10 is an explanatory diagram illustrating an example of processing by the information processing device.

FIG. 11 is an explanatory diagram illustrating a display example by the information processing device.

FIG. 12 is an explanatory diagram illustrating a display example by the information processing device.

FIG. 13 is an explanatory diagram illustrating an example of processing by the information processing device.

FIG. 14 is an explanatory diagram illustrating a display example by the information processing device.

FIG. 15 is an explanatory diagram illustrating a display example by the information processing device.

FIG. 16 is an explanatory diagram illustrating a display example by the information processing device.

FIG. 17 is an explanatory diagram illustrating an example of processing by the information processing device.

FIG. 18 is an explanatory diagram illustrating a display example by the information processing device.

FIG. 19 is an explanatory diagram illustrating a display example by the information processing device.

FIG. 20 is an explanatory diagram illustrating a display example by the information processing device.

FIG. 21 is an explanatory diagram illustrating an example of processing by the information processing device.

FIG. 22 is an explanatory diagram illustrating a display example by the information processing device.

FIG. 23 is an explanatory diagram illustrating a display example by the information processing device.

FIG. 24(a) is a side sectional view of an information processing device according to a second embodiment of the present disclosure. FIG. 24(b) is a plan sectional view of the information processing device.

FIG. 25 is a block diagram illustrating a configuration of the information processing device.

FIG. 26(a) is a side sectional view of a touch pad according to a modification of the present disclosure. FIG. 26(b) is a plan sectional view of the touch pad.

FIG. 27 is a block diagram illustrating a configuration of the touch pad.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

The description will be provided in the order shown below:

1. First Embodiment (example in which an input operation unit is a mouse)

1-1. Configuration of Mouse

1-2. Configuration of Information Processing Device

1-3. Processing by Information Processing Device

1-4. First Modification

1-5. Second Modification

2. Second Embodiment (example in which an information processing device is a so-called smartphone or the like, and an input operation unit is a touch panel inside the information processing device)

2-1. Configuration of Information Processing Device

2-2. Processing by Information Processing Device

2-3. Modification

### 1. First Embodiment

First, a first embodiment will be described.

### 1-1. Configuration of Mouse

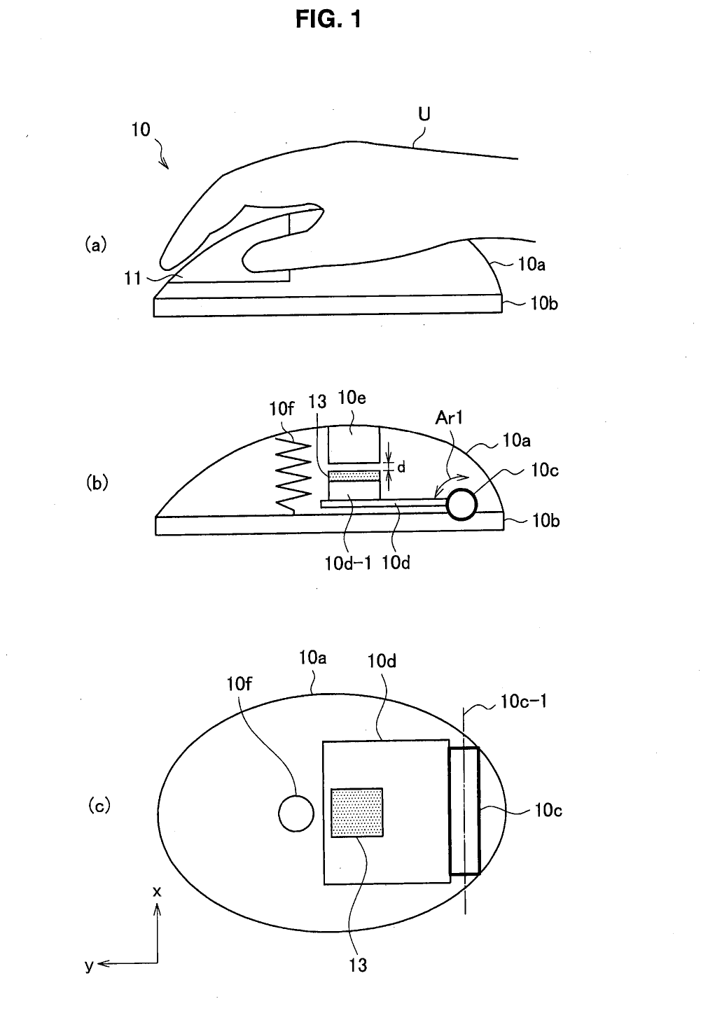

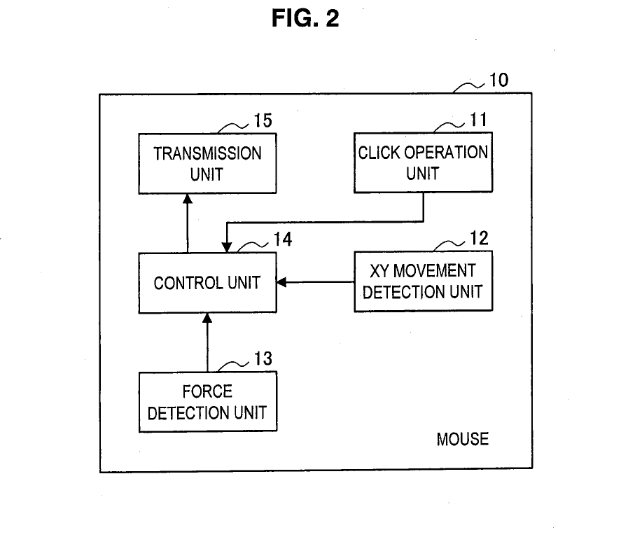

Schematically, an information processing device 20 according to a first embodiment sets a changing speed of an object, based on a weighting F acting on a mouse 10, and changes the object at the set changing speed. Thus, first, the configuration of the mouse 10 according to the first embodiment will be described with reference to FIGS. 1 and 2. The mouse 10 includes a cover portion 10a, a bottom portion 10b, a hinge 10c, a board 10d, a pressing member 10e, a compression coil spring 10f, a click operation unit 11, an XY movement detection unit 12, a force detection unit 13, a control unit 14, and a transmission unit 15. Incidentally, the mouse 10 includes a hardware configuration, such as a CPU, a ROM, a RAM, and a communication device. A program necessary for realizing the click operation unit 11, the XY movement detection unit 12, the force detection unit 13, the control unit 14, and the transmission unit 15 in the mouse 10 is stored in the ROM. Therefore, each element of the mouse 10 is realized by such a hardware configuration.

The cover portion 10a is a portion on which a palm of a user U (hereinafter, also simply referred to as a “user”) is placed, and the click operation unit 11 is provided at a front end of the cover portion 10a. Incidentally, in the first embodiment, one end of the respective ends of the cover portion 10a in a length direction is set as a front end, and the other end is set as a rear end. The same is applied to the other elements constituting the mouse 10. The cover portion 10a and the bottom portion 10b are connected by a flexible member (not illustrated). Thus, when the user presses the cover portion 10a, the flexible member is bent and the cover portion 10a is moved toward the bottom portion 10b. The bottom portion 10b is a portion constituting the bottom of the mouse 10. The respective elements constituting the mouse 10 are contained in a space surrounded by the cover portion 10a and the bottom portion 10b. Also, a through-hole penetrating the bottom portion 10b in a thickness direction is formed in the bottom portion 10b, and the XY movement detection unit 12 is provided in the through-hole. Also, the above-described hardware configuration is disposed on the surface of the bottom portion 10b (surface facing the cover portion 10a).

The hinge 10c is provided at the rear end of the bottom portion 10b and is rotatable in a direction of an arrow Ar1 with a rotational shaft 10c-1 as a rotation center. The rotational shaft 10c-1 is parallel to the bottom portion 10b and is perpendicular to the length direction of the mouse 10. The board 10d is rotated integrally with the hinge 10c. A base portion 10d-1 is provided at the front end of the board 10d, and the force detection unit 13 is provided on the base portion 10d-1. Also, a wiring for providing the control unit 14 with information from the force detection unit 13 is provided in the board 10d.

The pressing member 10e is provided on the rear surface of the cover portion 10a (surface facing the bottom portion 10b), and faces the force detection unit 13. Incidentally, a space (gap) d is formed between the pressing member 10e and the force detection unit 13. The compression coil spring 10f connects the cover portion 10a and the bottom portion 10b. The compression coil spring 10f holds the cover portion 10a above the bottom portion 10b, such that the space d is formed between the pressing member 10e and the force detection unit 13. Incidentally, the compression coil spring 10f is contracted when the user presses the cover portion 10, but a contraction amount is maximized (no more contraction) before the board 10d comes into contact with the bottom portion 10b.

The click operation unit 11 is a button that is to be pressed (clicked) by the user. When pressed by the user, the click operation unit 11 outputs click operation information indicating that effect to the control unit 14. The XY movement detection unit 12 detects a moving speed V1 of the mouse 10. Specifically, the XY movement detection unit 12 detects an x component V1x and a y component V1y of the moving speed V1. The XY movement detection unit 12 generates moving speed information related to the detected moving speed V1x and V1y, and outputs the moving speed information to the control unit 14. Incidentally, the XY movement detection unit 12 is not particularly limited as long as it can detect the moving speed V1 of the mouse 10, and has an arbitrary configuration, for example, a ball form, an LED form, or the like.

Here, as illustrated in FIG. 1(c), x-axis is a straight line extending in the width direction of the mouse 10 (vertical direction in FIG. 1(c)), and y-axis is a straight line extending in the length direction of the mouse 10. Also, a positive x-axis direction is an upper direction in FIG. 1(c), and a positive y-axis direction is a direction from the rear end to the front end of the mouse 10. The xy-axes and the positive direction of each axis may be set to other contents.

The force detection unit 13 is a sensor that detects a pressing force (weighting) F by the user. The configuration of the force detection unit 13 is not particularly limited as long as it can detect the weighting by the user. Examples of the force detection unit 13 include an electrostatic capacitance type sensor, a resistance type sensor, and a strain gauge sensor.

The electrostatic capacitance type sensor is constituted by, for example, a capacitor and the like, and detects a displacement of an electrode, which is caused by a weighting, as a change of electrostatic capacitance. That is, the electrostatic capacitance type sensor detects the weighting as a change amount of the electrostatic capacitance. In the resistance type sensor, for example, conductive particles are dispersed within the sensor. When a weighting acts on the resistance type sensor, the conductive particles are brought into contact with each other the weighting. Therefore, an electrical resistance of the resistance type sensor is changed. That is, the resistance type sensor detects the weighting as a change amount of the electrical resistance. In the strain gauge sensor, for example, a metal foil is attached to a thin insulator. When a weighting acts on the strain gauge sensor, the insulator and the metal foil are distorted and an electrical resistance of the metal foil is changed. That is, the strain gauge sensor detects the weighting as a change amount of the electrical resistance. When the force detection unit 13 detects the weighting by the user, the force detection unit 13 generates weighting information related to the magnitude of the weighting and outputs the weighting information to the control unit 14.

The control unit 14 controls the respective elements of the mouse 10, for example, the XY movement detection unit 12, the force detection unit 13, and the transmission unit 15. Also, the control unit 14 generates mouse operation information, including the click operation information, the moving speed information, and the weighting information, and outputs the mouse operation information to the transmission unit 15. The transmission unit 15 can perform wireless communication with the information processing device 20, and transmits the mouse operation information to the information processing device 20. That is, the mouse 10 is a so-called wireless mouse, but may be connected to the information processing device 20 through a cable.

Since the mouse 10 has the above-described configuration, the mouse 10 operates as follows. Before the user presses the cover portion 10a, the mouse 10 is in an initial state, that is, a state in which the space d is formed between the pressing member 10e and the force detection unit 13. When the user presses the cover portion 10a toward the bottom portion 10b, the compression coil spring 10f is contracted, while the pressing member 10e approaches the force detection unit 13. When the user presses the cover portion 10a as much as the space d, the pressing member 10e comes into contact with the force detection unit 13.

Therefore, when the user does not press the mouse 10 to some extent, the pressing effect (effect that the changing speed is adjusted according to the weighting F) cannot be obtained. In other words, the user can grasp a timing at which the pressing effect begins to work. After that, when the user further presses the cover portion 10a, the pressing member 10e presses the force detection unit 13, while the hinge 10c and the board 10d are rotated to the bottom portion 10b side. Therefore, the board 10d is prevented from being deflected by the weighting. When the user further presses the cover portion 10a, the contraction amount of the compression coil spring 10f is maximized before the board 10d comes into contact with the bottom portion 10b. Thus, the user cannot press the cover portion 10a anymore. Therefore, the bottom portion 10b is prevented from being damaged by the board 10d. After that, when the user finishes pressing, the compression coil spring 10f presses up the cover portion 10a. Therefore, the mouse 10 is returned to the initial state.

Thus, the user can perform the operation of pressing the mouse 10, as well as the operation of clicking the click operation unit 11 and the operation of moving the mouse 10 in the xy direction. That is, the user can input the operation information related to the changing speed (scroll speed, reproduction speed, and the like) of the object displayed on the display unit 24. Furthermore, the user can adjust the changing speed of the object by pressing the mouse 10.

### 1-2. Configuration of Information Processing Device

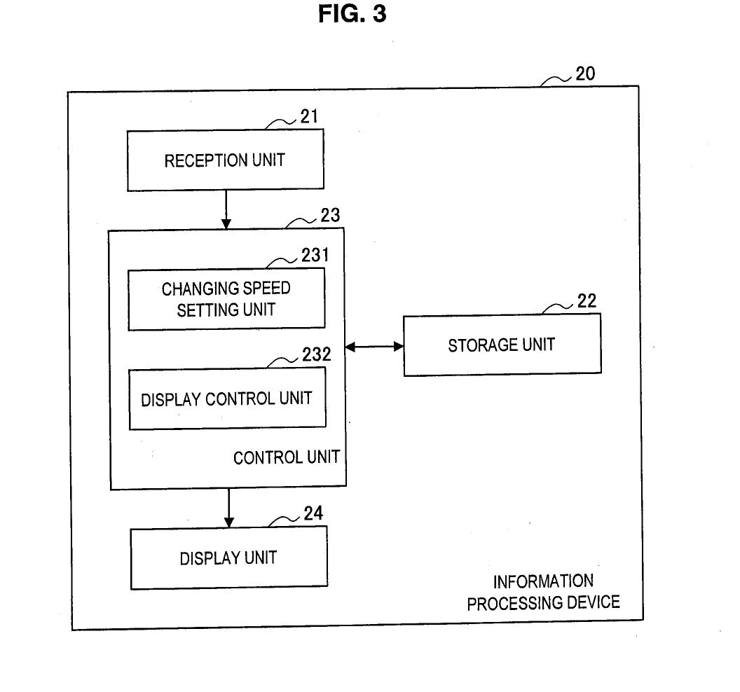

Next, the configuration of the information processing device 20 will be described with reference to FIGS. 3 to 5. The information processing device 20 is, for example, a desktop personal computer or a notebook computer, and includes a reception unit 21, a storage unit 22, a control unit 23, and a display unit 24. That is, the information processing device 20 includes a hardware configuration, such as a CPU, a ROM, a RAM, a hard disk, a display, and a communication device. A program for realizing the reception unit 21, the storage unit 22, the control unit 23, and the display unit 24 in the information processing device 20 is stored in the ROM. Thus, each element of the information processing device 20 is realized by such a hardware configuration.

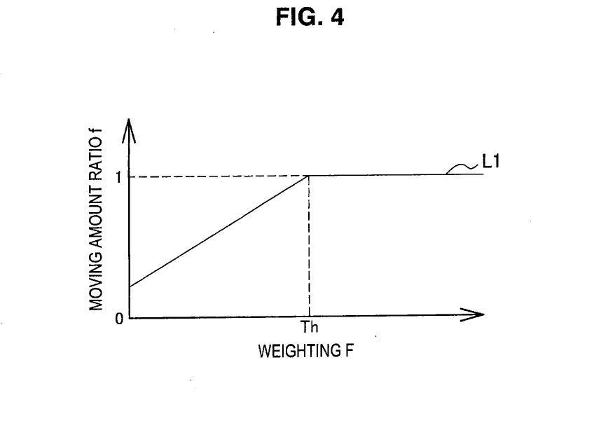

The reception unit 21 receives the mouse operation information and outputs the mouse operation information to the control unit 23. The storage unit 22 stores not only the above-described program but also a variety of image information, audio information, and a moving amount determination graph L1 illustrated in FIG. 4. The moving amount determination graph L1 shows the correspondence relation between the weighting F and the moving amount ratio f (f (V1x, V1y, F)). The moving amount ratio f is used for determining the scroll speed (changing speed) V2 of the object displayed on the display unit 24. Schematically, the scroll speed V2 of the object is the product of the moving speed V1 of the mouse 10 and the moving amount ratio f.

According to the moving amount determination graph L1, the relation between the weighting F and the moving amount ratio f is expressed by Formulas (1) and (2) below.

[Math. 1]

Where F≦Th, f=aF+b (1)

a: positive real number

b: positive real number less than 1

Where F>Th, f=1 (2)

Incidentally, specific values of a and b are appropriately set according to a resolution of the display unit 24, or the like. The magnitude of the threshold value Th is, for example, equal to or greater than 100 g weight and less than 1 kg weight, and preferably, equal to or greater than 300 g weight and less 400 g weight. a, b, and the threshold value Th may be changed according to a type of the object.

As shown in the moving amount determination graph L1, even in a case where the user does not press the mouse 10 (specifically, in a case where the pressing member 10e does not come into contact with the force detection unit 13, the same hereinafter), the moving amount ratio f takes a positive value less than 1. Therefore, even in a case where the user does not press the mouse 10, the object is changed, but the moving speed V1 of the mouse 10 and the scroll speed V2 of the object are not matched with each other. Also, in a case where the weighting F is equal to or less than the threshold value Th, the moving amount ratio f is changed in proportion to the weighting F. Also, in a case where the weighting F is greater than the threshold value Th, the moving amount ratio f is always 1.

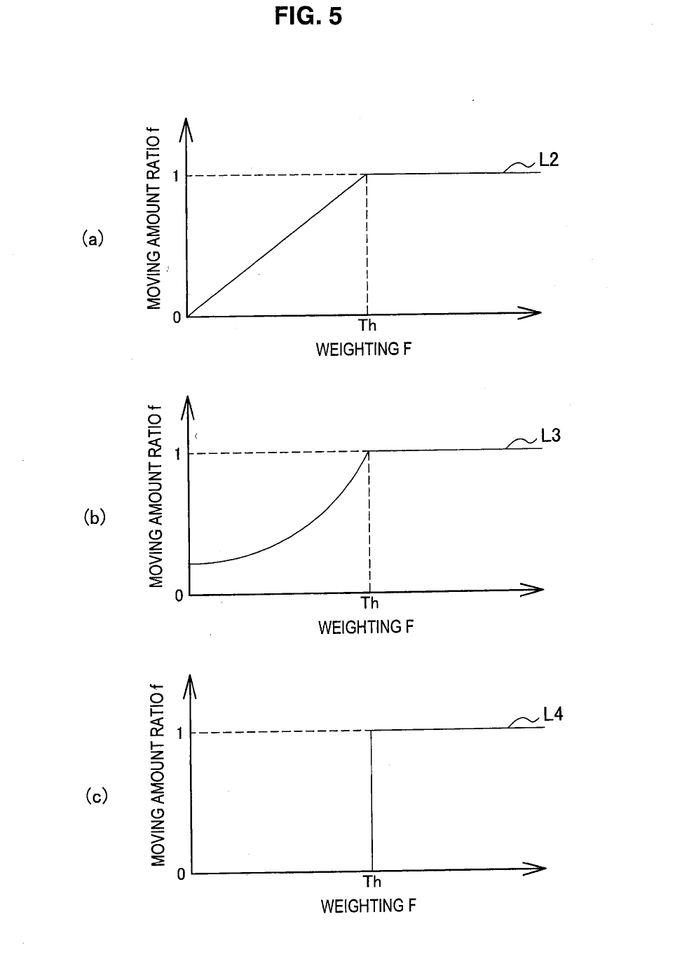

FIG. 5 illustrates moving amount determination graphs L2 to L4 according to modifications of the moving amount determination graph L1. The storage unit 22 may store at least one of the moving amount determination graphs L1 to L4.

According to the moving amount determination graph L2, the relation between the weighting F and the moving amount ratio f is expressed by Formulas (3) and (4) below.

[Math. 2]

Where F≦Th, f=aF (3)

Where F>Th, f=1 (4)

As shown in the moving amount determination graph L2, in a case where the user does not press the mouse 10, the moving amount ratio f is zero. Therefore, in a case where the user does not press the mouse 10, the object is changed even when the user moves the mouse 10 in the xy direction. Also, in a case where the weighting F is equal to or less than the threshold value Th, the moving amount ratio f is changed in proportion to the weighting F. Also, in a case where the weighting F is greater than the threshold value Th, the moving amount ratio f is always 1.

According to the moving amount determination graph L3, the relation between the weighting F and the moving amount ratio f is expressed by Formulas (5) and (6) below.

[Math. 3]

Where F≦Th. f=aF²+b (5)

Where F>Th, f=1 (6)

As shown in the moving amount determination graph L3, in a case where the user does not press the mouse 10, the moving amount ratio f is a positive value. Also, in a case where the weighting F is equal to or less than the threshold value Th, the moving amount ratio f is changed in proportion to the square of the weighting F. That is, as the weighting F is increased, the changing amount of the moving amount ratio f is increased. Also, in a case where the weighting F is greater than the threshold value Th, the moving amount ratio f is always 1.

According to the moving amount determination graph L4, the relation between the weighting F and the moving amount ratio f is expressed by Formulas (7) and (8) below.

[Math. 4]

Where F≦Th, f=0 (7)

Where F>Th, f=1 (8)

As shown in the moving amount determination graph L4, the moving amount ratio f is zero until the weighting F is greater than the threshold value Th. Also, in a case where the weighting F is greater than the threshold value Th, the moving amount ratio f is always 1. Therefore, if the user does not press the mouse 10 to some extent, the object is not changed.

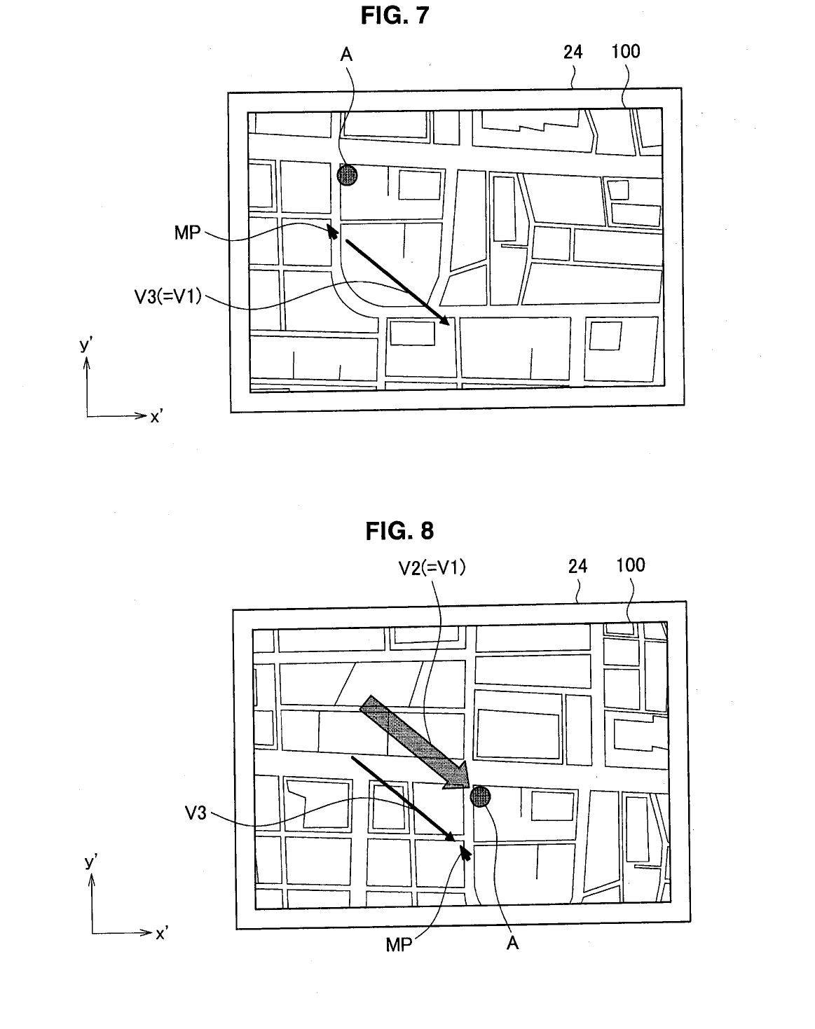

The control unit 23 controls the respective elements of the information processing device 20, and also functions as a changing speed setting unit 231 and a display control unit 232. The changing speed setting unit 231 sets the scroll speed V2 of the object, based on the mouse operation information provided from the reception unit 21 and the moving amount determination graph L1 illustrated in FIG. 4. The display control unit 233 displays the object on the display unit 24, and changes the object at the scroll speed V2. The display unit 24 displays various objects under the control of the display control unit 233. Incidentally, as illustrated in FIG. 7, x′y′-axes are set on the display screen of the display unit 24. A horizontal direction is the x′-axis and a vertical axis is the y′-axis. Also, in FIG. 7, a right direction is a positive x′-axis direction and an upward direction is a positive y-axis direction. The x′-axis corresponds to the above-described x-axis, and the y′-axis corresponds to the above-described y-axis.

### 1-3. Processing by Information Processing Device

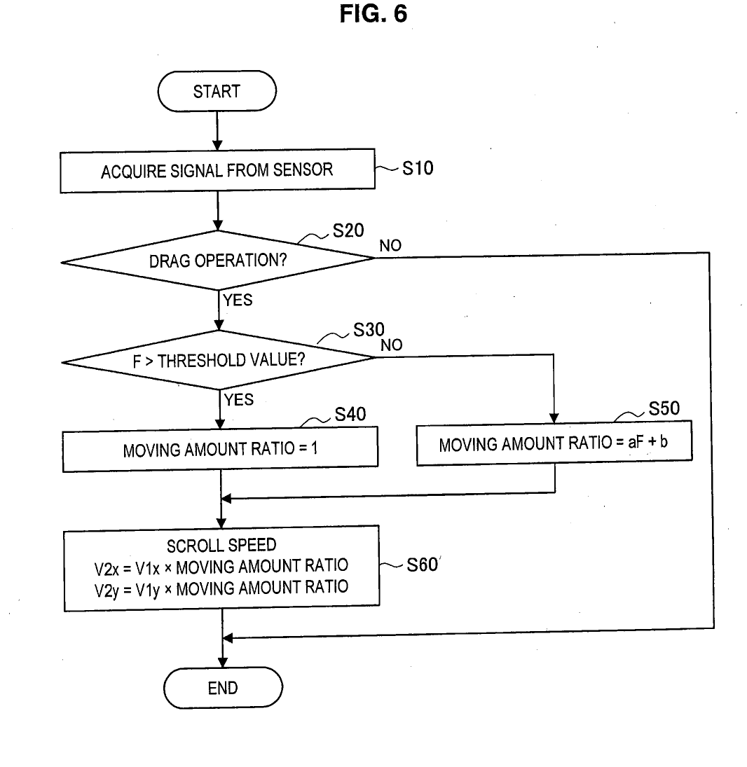

Next, the processing by the information processing device 20 will be described. In the first embodiment, the information processing device 20 sets the scroll speed V2 of the object, based on the force by which the user presses the mouse 10, that is, the weighting F. First, processing of adjusting the scroll speed V2 will be described with reference to FIG. 6. Incidentally, herein, processing of the case of scrolling a map image 100 as the object, as illustrated in FIG. 7, will be described as an example.

In step S10, the display unit 24 displays a map image 100 and a mouse pointer MP as illustrated in FIG. 7. The mouse pointer MP is moved in such a manner that the user moves the mouse 10 in the xy direction. Also, a moving speed V3 of the mouse pointer MP is matched with the moving speed V1 of the mouse 10, regardless of the magnitude of the weighting F. The same applies hereinafter.

That is, in a case where the user moves the mouse pointer MP, the mouse 10 is moved in the xy direction. Therefore, the XY movement detection unit 12 detects the moving speed V1(=(V1x, V1y)) of the mouse 10, and outputs the moving speed information related to the moving speed V1 to the control unit 14. The control unit 14 generates mouse operation information including the moving speed information, and outputs the mouse operation information to the transmission unit 15. The transmission unit 15 transmits the mouse operation information to the information processing device 20. The reception unit 21 of the information processing device 20 receives the mouse operation information and outputs the mouse operation information to the changing speed setting unit 231. The changing speed setting unit 231 changes the moving speed V1x and V1y to values based on x′y′ coordinates, respectively.

Then, the changing speed setting unit 231 sets an x′ component V3x of the moving speed V3 of the mouse pointer MP to V1x, and sets a y′ component V3y to V1y. The display control unit 232 moves the mouse pointer MP at the moving speed V3. In FIG. 7, the moving speed V3 of the mouse pointer MP is indicated by a vector. In the respective display examples below, the respective speeds such as the moving speed of the mouse pointer MP are indicated by vectors.

Then, the mouse pointer MP is moved on the map image 100 in such a manner that the user moves the mouse 10 in the xy direction. Then, the user performs a so-called drag operation. Herein, a drag operation is an operation of moving the mouse 10 in the xy direction while pressing the click operation unit 11. Incidentally, for example, in a case where the click operation unit 11 includes a left click button and a right click button, a button to be pressed is the left click button. For example, in a case where the click operation unit 11 includes a scroll button, a button to be pressed is the scroll button. Also, in a case where the scroll speed V2 of the map image 100 is adjusted based on the weighting F, the user performs the drag operation while pressing the mouse 10.

The click operation unit 11 outputs click operation information, indicating the effect of being pressed by the user, to the control unit 14. The XY movement detection unit 12 detects the moving speed V1 of the mouse 10, and outputs moving speed information related to the detected moving speed V1 to the control unit 14. The force detection unit 13 detects the weighting F by the user, and outputs weighting information related to the detected weighting F to the control unit 14. The control unit 14 generates mouse operation information, including the click operation information, the moving speed information, and the weighting information, and outputs the mouse operation information to the transmission unit 15. The transmission unit 15 transmits the mouse operation information to the information processing device 20. The reception unit 21 of the information processing device 20 receives the mouse operation information and outputs the mouse operation information to the changing speed setting unit 231.

Then, in step S20, the changing speed setting unit 231 determines whether the user has performed the drag operation based on the mouse operation information. Specifically, the changing speed setting unit 231 determines that the user has performed the drag operation when the click operation information is included in the mouse operation information and the moving speed V1 of the mouse 10 is non-zero. The changing speed setting unit 231 proceeds to step S30 when it is determined that the user has performed the drag operation, and ends the processing when it is determined when the user has not performed the drag operation.

Then, in step S30, the changing speed setting unit 231 determines whether the weighting F is greater than the threshold value Th, based on the mouse operation information and the moving amount determination graph L1. The changing speed setting unit 231 proceeds to step S40 when it is determined that the weighting F is greater than the threshold value Th, and proceeds to step S50 when it is determined that the weighting F is equal to or less than the threshold value Th.

In step S40, since the weighting F is greater than the threshold value Th, the changing speed setting unit 231 determines the moving amount ratio f to 1. On the other hand, in step S50, since the weighting F is equal to or less than the threshold value Th, the changing speed setting unit 231 determines the moving amount ratio f to (aF+b).

In step S60, the changing speed setting unit 231 changes the moving speed V1x and V1y to values based on x′y′ coordinates, respectively. Then, the changing speed setting unit 231 sets an x′ component V2x and a y′ component V2y of the scroll speed V2, based on Formulas (9) and (10) below.

[Math. 5]

V2x=V1x×f (9)

V2y=V1y×f (10)

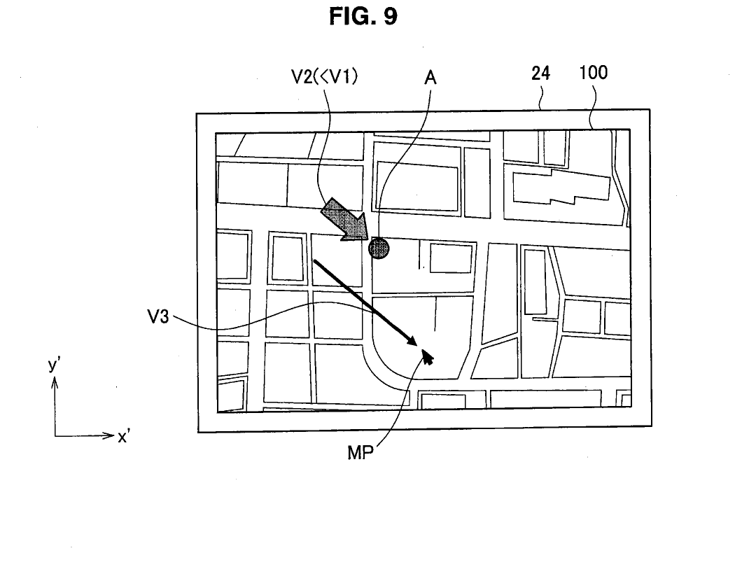

The display control unit 232 scrolls the map image 100 at the scroll speed V2. Then, the information processing device 20 ends the processing. An example of scroll speed adjustment is illustrated in FIGS. 8 and 9. In a case where the weighting F is greater than the threshold value Th, as illustrated in FIG. 8, the scroll speed V2 is matched with the moving speed V3 of the mouse pointer MP, that is, the moving speed V1 of the mouse 10. Therefore, the map image 100 is scrolled while completely following the movement of the mouse pointer MP (that is, scrolled at the original scroll speed). On the other hand, in a case where the weighting F is equal to or less than the threshold value F, as illustrated in FIG. 9, the scroll speed V2 is less than the moving speed V3 of the mouse pointer MP, that is, the moving speed V1 of the mouse 10. Therefore, the map image 100 does not completely follow the movement of the mouse pointer MP and is scrolled as if it is dragged by the mouse pointer MP. Thus, since the user can reflect not only the operation of moving the mouse 10 in the xy direction but also the operation of pressing the mouse 10 to the movement of the map image 100, the map image 100 can be scrolled in more detail. Also, since the user can obtain an operation feeling as if the friction force acts between the mouse pointer MP and the map image 100, the user can operate the map image 100 with a more natural operation feeling.

In a case where the user stops pressing the click operation unit 11 while continuing to move the mouse 10 in the xy direction after the click operation, the display control unit 232 continuously scrolls the map image 100. That is, the display control unit 232 performs inertial scroll on the map image 100. The inertial scroll is a scroll that is continuously performed after the user finishes the drag operation. The scroll speed V2 at the time of the inertial scroll is reduced with the passage of time, but the scroll speed V2 at the start of the inertial scroll is maintained. That is, the scroll speed V2 may not be necessarily reduced with the passage of time (in other words, the map image 100 may be uniformly moved with zero friction).

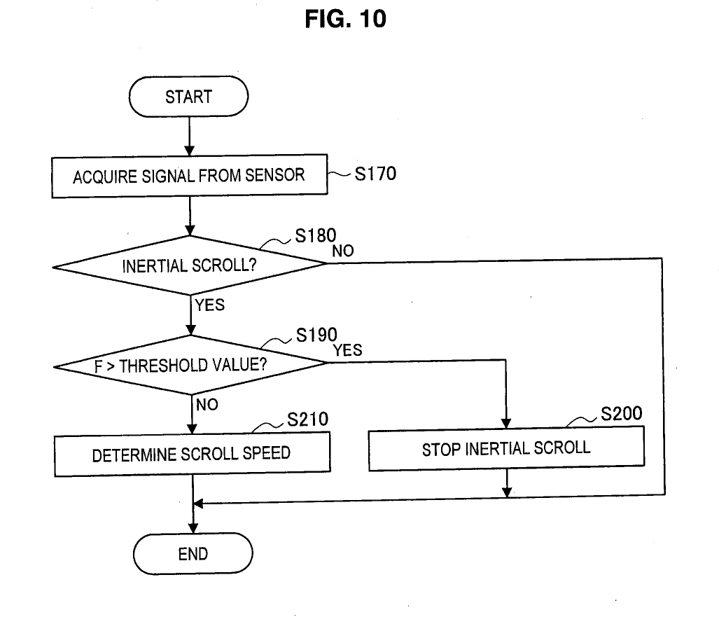

Therefore, the scroll speed V2 at the time of the inertial scroll is reduced with the passage of time, but the scroll speed V2 is also reduced when the user just presses the mouse 10. Hereinafter, details will be described with reference to FIG. 10.

In step S170, the user moves the mouse pointer MP onto the map image 100 during the inertial scroll. Then, the user presses the mouse 10. Therefore, the force detection unit 13 detects the weighting F and outputs weighting information related to the weighting F to the control unit 14. The control unit 14 generates mouse operation information including the weighting information, and outputs the mouse operation information to the transmission unit 15. The transmission unit 15 transmits the mouse operation information to the information processing device 20. The reception unit 21 of the information processing device 20 receives the mouse operation information and outputs the mouse operation information to the changing speed setting unit 231.

In step S180, the changing speed setting unit 231 determines whether the map image 100 is in the process of inertial scroll. The changing speed setting unit 231 proceeds to step S190 when it is determined that the map image 100 is in the process of inertial scroll, and ends the processing when it is determined when the map image 100 is not in the process of inertial scroll.

In step S190, the changing speed setting unit 231 determines whether the weighting F is greater than the threshold value Th. The changing speed setting unit 231 proceeds to step S200 when it is determined that the weighting F is greater than the threshold value Th, and proceeds to step S210 when it is determined that the weighting F is equal to or less than the threshold value Th.

In step S200, the changing speed setting unit 231 sets the scroll speed V2 to zero. Thus, the display control unit 232 stops the map image 100. Then, the information processing device 20 ends the processing. Incidentally, the processing of steps S190 to S200 may not be performed. In this case, the information processing device 20 proceeds to step S210 immediately after the completion of the processing of step S180.

In step S210, the changing speed setting unit 231 sets the scroll speed V2, based on Formulas (11) to (14) below.

[Math. 6]

Where V2x(t−1)>0 and V2x(t−1)>Const×F V2x(t)=V2x(t−1)−Const×F (11)

Where V2x(t−1)>0 and V2x(t−1)≦Const×F V2x(t)=0 (12)

Where V2x(t−1)<0 and |V2x(t−1)|>Const×F V2x(t)=V2x(t−1)+Const×F (13)

Where V2x(t−1)>0 and |V2x(t−1)|≦Const×F V2x(t)=0 (14)

Herein, V2x (t) is V2x at a certain time t (s), and Const is a positive real number.
V2y is also set in a similar manner.
In Formulas (11) to (14), the Const×F part may be an nth-order function of F or an exponential function.

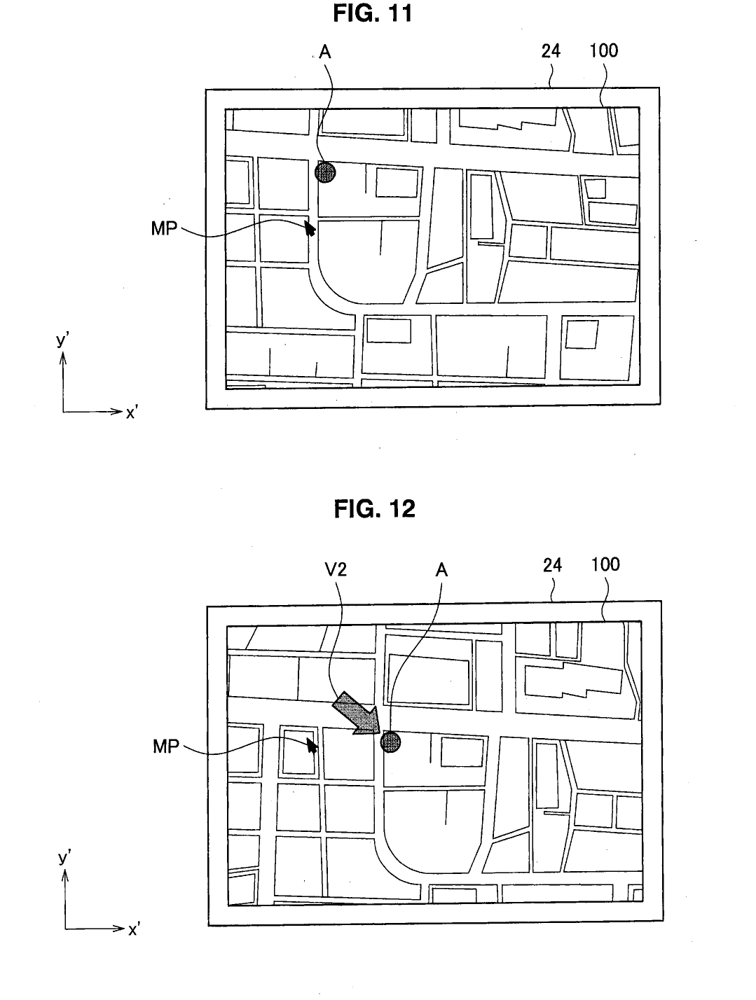

Then, the display control unit 232 scrolls the map image 100 at the scroll speed V2. An example at the time of scroll deceleration is illustrated in FIGS. 11 and 12. In this example, the map image 100 is decelerated from a state illustrated in FIG. 11. In a case where the weighting F is greater than the threshold value Th, the map image 100 is immediately stopped. On the other hand, in a case where the weighting F is equal to or less than the threshold value Th, as illustrated in FIG. 12, the scroll speed V2 is reduced according to the weighting F. Thus, since the user can reflect the operation of pressing the mouse 10 to the deceleration of the map image 100, the map image 100 can be scrolled in more detail. Also, since the user can obtain an operation feeling as if the friction force acts between the mouse pointer MP and the map image 100, the user can operate the map image 100 with a more natural operation feeling. That is, the user can reduce the scroll speed V2 of the map image 100 by a friction force corresponding to the weighting F. Therefore, the user can operate the map image 100 with a more natural operation feeling.

Incidentally, in the above example, the information processing device 20 has adjusted the scroll speed V2 of the map image 100 based on the weighting F, but may adjust an enlargement/reduction speed of the map image 100 based on the weighting F. In this case, for example, a zoom button is included in the click operation unit 11. Then, the user performs a drag operation while pressing the mouse 10. Herein, a button to be pressed in the drag operation is the zoom button. Therefore, the map image 100 is enlarged/reduced at a speed corresponding to the weighting F. A center of enlargement/reduction is, for example, a center of the map image 100 or a position of the mouse pointer MP at the start of enlargement/reduction.

### 1-4. First Modification

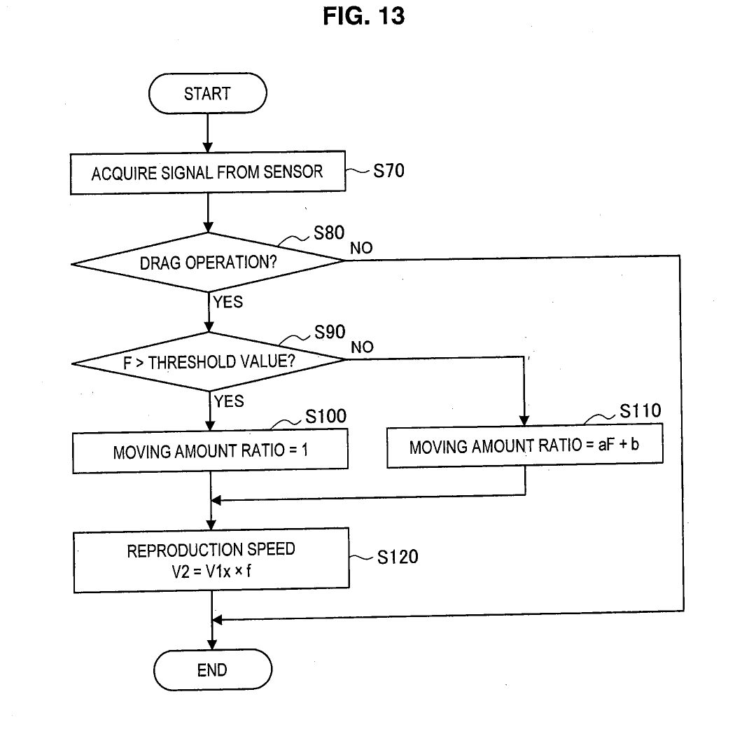

Next, a first modification of the information processing device 20 will be described. In the first embodiment, in a case where the object is a moving image, the information processing device 20 sets a reproduction speed V2, which is the changing speed V2 of the object, based on the force by which the user presses the mouse 10, that is, the weighting F. First, the processing of adjusting the reproduction speed V2 will be described with reference to FIG. 13. Incidentally, herein, processing of the case of reproducing the moving image 200 as illustrated in FIG. 14 will be described as an example. The moving image 200 is that a character 201 is moved to the left side from a position of FIG. 14.

In step S70, the display unit 24 displays the moving image 200 and a mouse pointer MP as illustrated in FIG. 14. Then, by moving the mouse 10 in the xy direction, the user moves the mouse pointer MP onto the moving image 200. Then, the user performs a so-called drag operation. Also, in the case of adjusting the reproduction speed V2 of the moving image 200 based on the weighting F, the user performs a drag operation while pressing the mouse 10.

The click operation unit 11 outputs click operation information, indicating the effect of being pressed by the user, to the control unit 14. The XY movement detection unit 12 detects the moving speed V1 of the mouse 10, and outputs moving speed information related to the detected moving speed V1 to the control unit 14. The force detection unit 13 detects the weighting F by the user, and outputs weighting information related to the detected weighting F to the control unit 14. The control unit 14 generates mouse operation information, including the click operation information, the moving speed information, and the weighting information, and outputs the mouse operation information to the transmission unit 15. The transmission unit 15 transmits the mouse operation information to the information processing device 20. The reception unit 21 of the information processing device 20 receives the mouse operation information and outputs the mouse operation information to the changing speed setting unit 231.

Then, in step S80, the changing speed setting unit 231 determines whether the user has performed the drag operation based on the mouse operation information. Specific processing is similar to step S20 described above. The changing speed setting unit 231 proceeds to step S90 when it is determined that the user has performed the drag operation, and ends the processing when it is determined when the user has not performed the drag operation.

Then, in step S90, the changing speed setting unit 231 determines whether the weighting F is greater than the threshold value Th, based on the mouse operation information and the moving amount determination graph L1. The changing speed setting unit 231 proceeds to step S100 when it is determined that the weighting F is greater than the threshold value Th, and proceeds to step S110 when it is determined that the weighting F is equal to or less than the threshold value Th.

In step S100, since the weighting F is greater than the threshold value Th, the changing speed setting unit 231 determines the moving amount ratio f to 1. On the other hand, in step S110, since the weighting F is equal to or less than the threshold value Th, the changing speed setting unit 231 determines the moving amount ratio f to (aF+b).

In step S120, the changing speed setting unit 231 changes the moving speed V1x and V1y to values based on x′y′ coordinates, respectively. Then, the changing speed setting unit 231 sets the reproduction speed V2, based on Formula (15) below.

[Math. 7]

V2V1x×f (15)

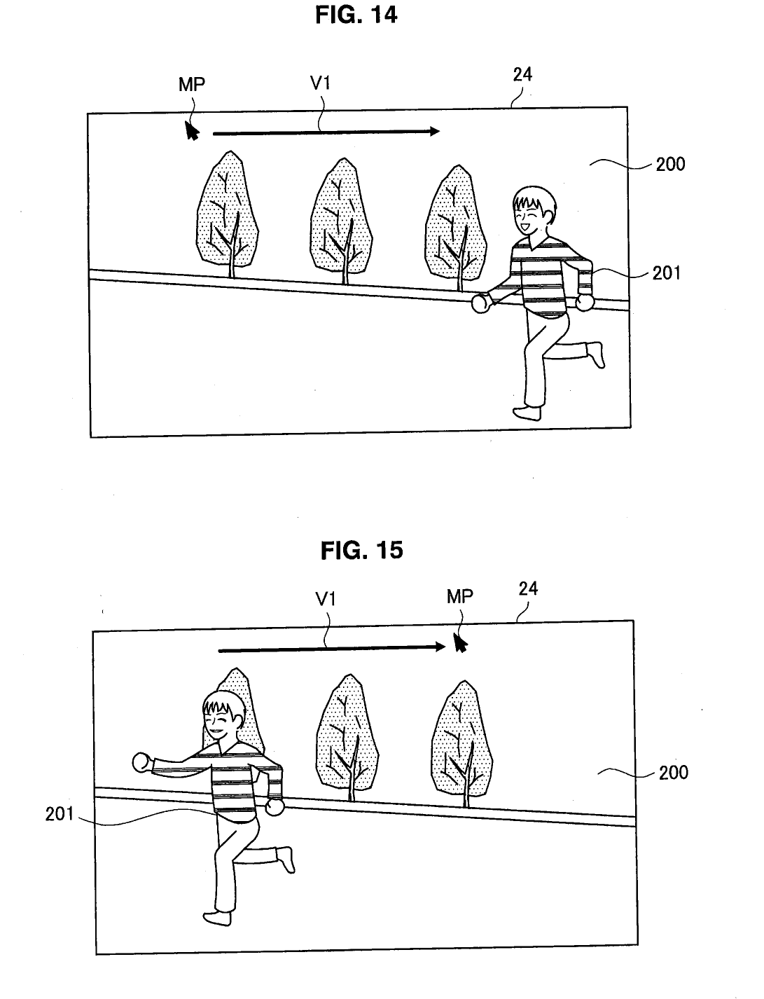

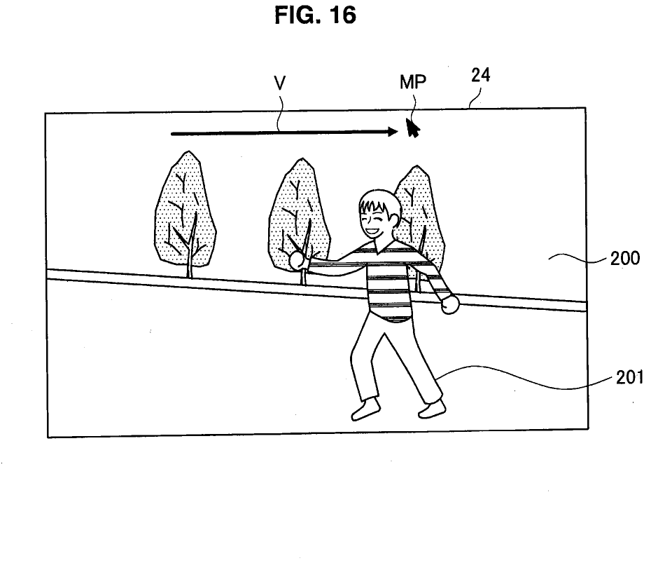

The display control unit 232 reproduces the moving image 200 at the reproduction speed V2. Herein, a reproduction direction is a forward direction when the reproduction speed V2 is positive, and is a reverse direction when the reproduction speed V2 is negative. Then, the information processing device 20 ends the processing. An example of reproduction speed adjustment is illustrated in FIGS. 14 to 16. In a case where the weighting F is greater than the threshold value Th, as illustrated in FIG. 15, the reproduction speed V2 is matched with the moving speed V3 of the mouse pointer MP, that is, the moving speed V1 of the mouse 10. Therefore, the moving image 200 is reproduced while completely following the movement of the mouse pointer MP. On the other hand, in a case where the weighting F is equal to or less than the threshold value F, as illustrated in FIG. 16, the reproduction speed V2 is less than the moving speed V3 of the mouse pointer MP, that is, the moving speed V1 of the mouse 10. Therefore, the moving image 200 does not completely follow the movement of the mouse pointer MP and is reproduced as if it is dragged by the mouse pointer MP.

Thus, since the user can reflect not only the operation of moving the mouse 10 in the xy direction but also the operation of pressing the mouse 10 to the reproduction speed of the moving image 200, the moving image 200 can be reproduced in more detail. Also, since the user can obtain an operation feeling as if the friction force acts on the moving image 200 in a direction opposite to the reproduction direction, the user can operate the moving image 200 with a more natural operation feeling.

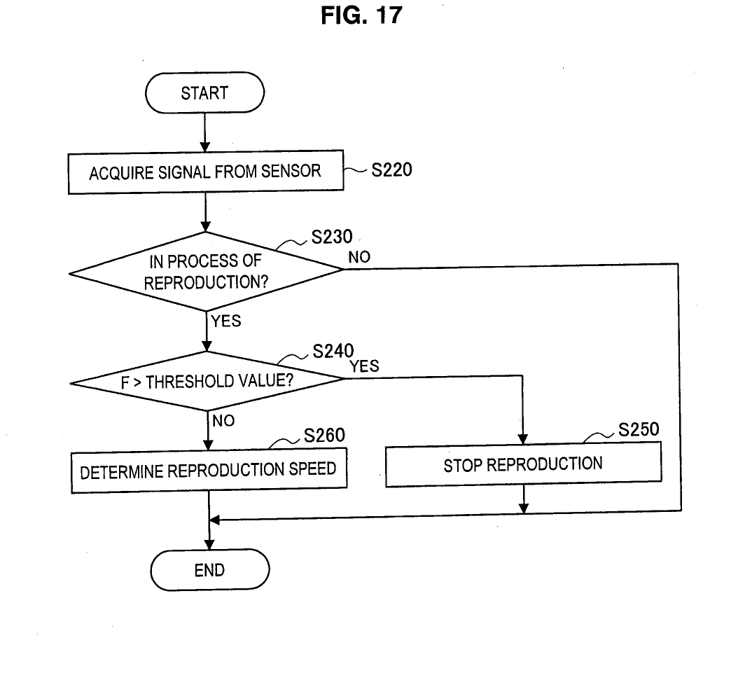

Next, the processing of reducing the reproduction speed V2 of the moving image 200 will be described in detail with reference to FIG. 17. In step S220, the user moves the mouse pointer MP onto the moving image 200 being reproduced. Then, the user presses the mouse 10. Therefore, the force detection unit 13 detects the weighting F and outputs weighting information related to the weighting F to the control unit 14. The control unit 14 generates mouse operation information including the weighting information, and outputs the mouse operation information to the transmission unit 15. The transmission unit 15 transmits the mouse operation information to the information processing device 20. The reception unit 21 of the information processing device 20 receives the mouse operation information and outputs the mouse operation information to the changing speed setting unit 231.

In step S230, the changing speed setting unit 231 determines whether the moving image 200 is in the process of reproduction. The changing speed setting unit 231 proceeds to step S240 when it is determined that the moving image 200 is in the process of reproduction, and ends the processing when it is determined when the moving image 200 is not in the process of reproduction.

In step S240, the changing speed setting unit 231 determines whether the weighting F is greater than the threshold value Th. The changing speed setting unit 231 proceeds to step S250 when it is determined that the weighting F is greater than the threshold value Th, and proceeds to step S260 when it is determined that the weighting F is equal to or less than the threshold value Th.

In step S250, the changing speed setting unit 231 sets the reproduction speed V2 to zero. Thus, the display control unit 232 stops the moving image 200. Then, the information processing device 20 ends the processing. Incidentally, the processing of steps S240 to S250 may not be performed. In this case, the information processing device 20 proceeds to step S260 immediately after the completion of the processing of step S230.

In step S260, the changing speed setting unit 231 sets the reproduction speed V2, based on Formulas (16) to (19) below.

[Math. 8]

Where V2(t−1)>0 and V2(t−1)>Const×F V2(t)=V2(t−1)−Const×F (16)

Where V2(t−1)>0 and V2(t−1)≦Const×F V2(t)=0 (17)

Where V2(t−1)<0 and |V2(t−1)|>Const×F V2(t)=V2(t−1)+Const×F (18)

Where V2(t−1)>0 and |V2(t−1)|≦Const×F V2(t)=0 (19)

Herein, V2 (t) is V2 at a certain time t (s), and Const is a positive real number.

In Formulas (16) to (19), the Const×F part may be an nth-order function of F or an exponential function.

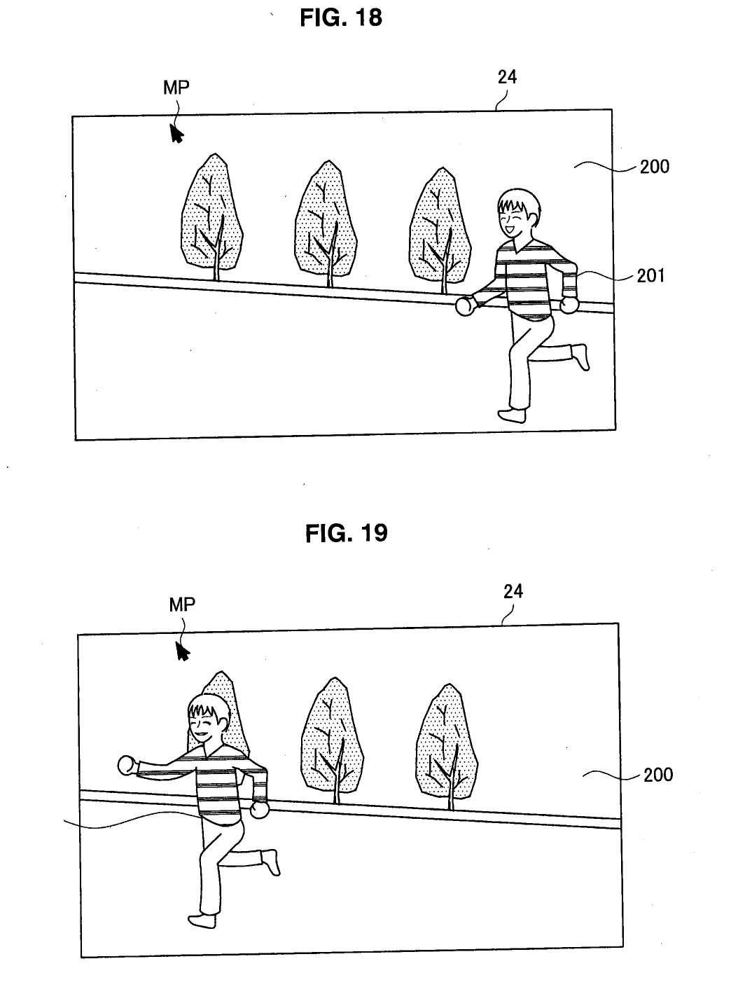

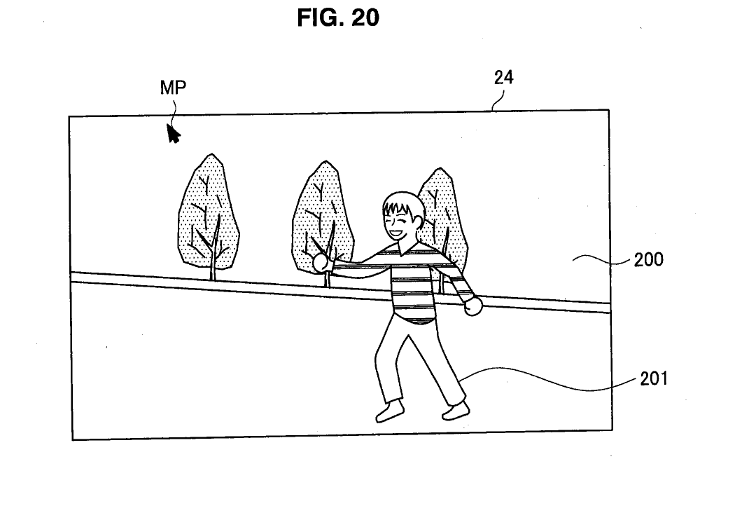

Then, the display control unit 232 reproduces the moving image 200 at the reproduction speed V2. An example of reproduction speed reduction is illustrated in FIGS. 18 to 20. In this example, the moving image 200 is reproduced from a state illustrated in FIG. 18. In a case where the weighting F is greater than the threshold value Th, the moving image 200 is immediately stopped. On the other hand, in a case where the weighting F is equal to or less than the threshold value Th, as illustrated in FIGS. 19 and 20, the reproduction speed V2 is reduced according to the weighting F. That is, the weighting F of the case illustrated in FIG. 19 is less than the weighting F illustrated in FIG. 20. Thus, since the user can reflect the operation of pressing the mouse 10 to the reproduction speed of the moving image 200, the moving image 200 can be reproduced in more detail. Also, the user can obtain an operation feeling as if the friction force acts in a direction opposite to the reproduction direction of the moving image 200. That is, the user can reduce the reproduction speed V2 of the moving image 200 by the friction force corresponding to the weighting F. Therefore, the user can operate the moving image 200 with a more natural operation feeling.

### 1-5. Second Modification

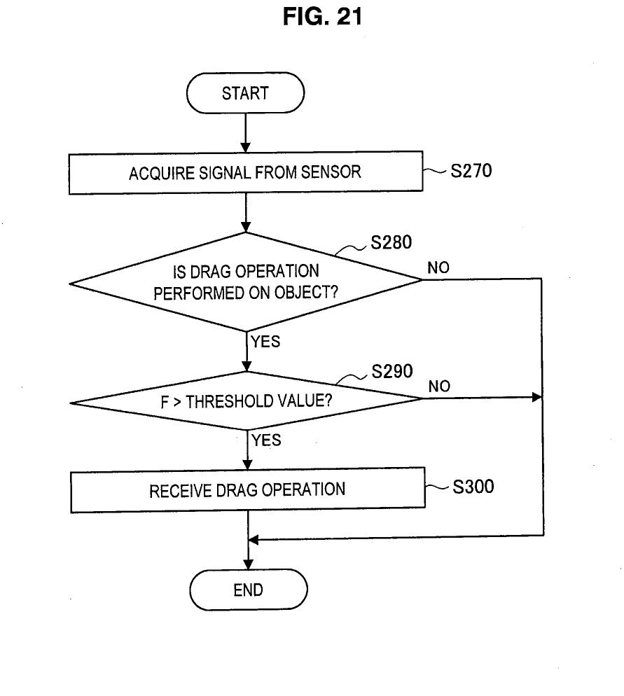

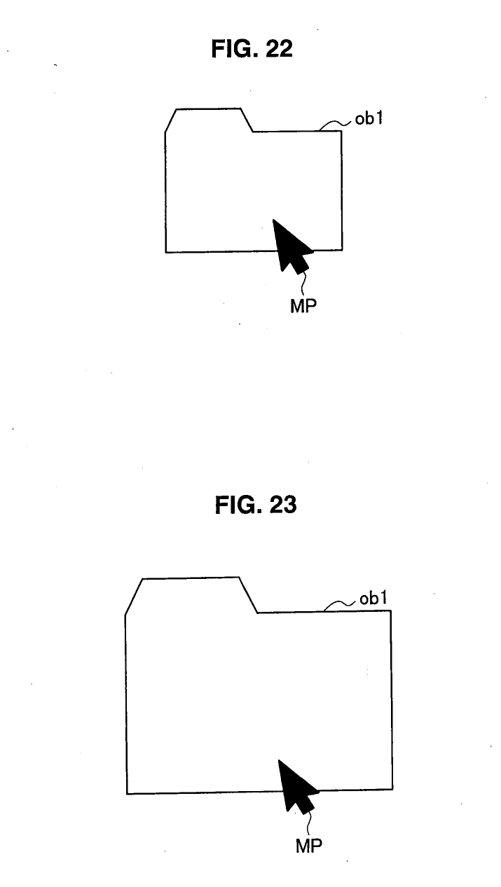

Next, a second modification of the information processing device 20 will be described. The information processing device 20 according to the second modification receives a drag operation on objects such as windows or various icons under a certain condition. Also, the storage unit 22 stores at least the moving amount determination graph L4 illustrated in FIG. 5(c). Next, processing, which is performed by the information processing device 20, will be described with reference to FIG. 21. Incidentally, herein, processing of the case where the user drags a folder Ob1 as illustrated in FIG. 22 will be described as an example.

In step S270, the display unit 24 displays the folder Ob1 and a mouse pointer MP as illustrated in FIG. 22. Then, the user moves the mouse pointer MP onto the folder Ob1 by moving the mouse 10 in the xy direction. Then, the user performs a drag operation while pressing the mouse 10.

The click operation unit 11 outputs click operation information, indicating the effect of being pressed by the user, to the control unit 14. The XY movement detection unit 12 detects the moving speed VI of the mouse 10, and outputs moving speed information related to the detected moving speed V1 to the control unit 14. The force detection unit 13 detects the weighting F by the user, and outputs weighting information related to the detected weighting F to the control unit 14. The control unit 14 generates mouse operation information, including the click operation information, the moving speed information, and the weighting information, and outputs the mouse operation information to the transmission unit 15. The transmission unit 15 transmits the mouse operation information to the information processing device 20. The reception unit 21 of the information processing device 20 receives the mouse operation information and outputs the mouse operation information to the changing speed setting unit 231.

Then, in step S280, the changing speed setting unit 231 determines whether the user has performed the drag operation on the folder Ob1, based on the mouse operation information. Specific processing is similar to step S20 described above. The changing speed setting unit 231 proceeds to step S290 when it is determined that the user has performed the drag operation, and ends the processing when it is determined when the user has not performed the drag operation.

Then, in step S290, the changing speed setting unit 231 determines whether the weighting F is greater than the threshold value Th, based on the mouse operation information and the moving amount determination graph L4. The changing speed setting unit 231 proceeds to step S300 when it is determined that the weighting F is greater than the threshold value Th, and ends the processing when it is determined that the weighting F is equal to or less than the threshold value Th.

In step S300, since the weighting F is greater than the threshold value Th, the changing speed setting unit 231 determines the moving amount ratio f to 1. The changing speed setting unit 231 sets an x′ component V2x and a y′ component V2y of the moving speed V2, which is the changing speed V2 of the folder Ob1, based on Formulas (20) and (21) below.

[Math. 9]

V2x=V1x×f (20)

V2y=V1y×f (21)

The display control unit 232 moves (drags) the folder Ob1 at the moving speed V2. That is, the information processing device 20 receives the drag operation. Incidentally, in the case of moving the folder Ob1, the display control unit 232 may enlarge the folder Ob1 as illustrated in FIG. 23. Therefore, the user can easily grasp the folder Ob1 is drag-operable. Incidentally, in addition to the enlargement of the folder Ob1, the display control unit 232 may perform, for example, processing such as a color change so as to make the folder Ob1 as a collapsed image.

Therefore, according to the first embodiment, the information processing device 20 sets the changing speed of the object based on the weighting F to the mouse 10, and changes the object at the changing speed. Thus, since the user can reflect not only the operation of determining the changing direction of the object (that is, the operation of moving the mouse 10 in the xy direction) but also the operation of pressing the mouse 10 to the changing speed of the object, the user can operate the object in more detail.

That is, the information processing device 20 replaces the weighting F with the “friction force”, which is a phenomenon familiar to the user, and exerts the “friction force” on the folder. Therefore, the user can obtain an operation feeling as if the friction force acts on the object. Therefore, the information processing device 20 can provide an operation control system that is natural to the user and easy to understand.

Furthermore, the information processing device 20 changes the moving speed V1 based on the moving speed V1 of the mouse 10, and changes the changing speed V2 of the object based on the weighting F. Therefore, the user can adjust the changing speed V2 of the object by adjusting the moving speed V1 of the mouse 10 and the weighting F. That is, the user can operate the object in more detail.

Also, as the weight F is increased, the information processing device 20 sets the changing speed V2 to be closer to the moving speed V1 of the mouse 10. Thus, since the user can exert a friction force to the object as strong as the mouse 10 is strongly pressed, the user can operate the object at a more natural spacing.

Also, in a case where the weighting F is greater than the threshold value Th, the information processing device 20 matches the changing speed V2 of the object with the moving speed V1 of the mouse 10. Thus, the user can change the object at the moving speed V1 of the mouse 10 by pressing the mouse 10 with the weighting F greater than the threshold value Th.

Also, as the weight F is increased, the information processing device 20 sets the changing speed of the object to a smaller value. Thus, since the user can decelerate the object as much as the mouse 10 is strongly pressed, the user can operate the object with a more natural operation feeling.

Also, in a case where the weighting F is greater than the threshold value Th, the information processing device 20 sets the changing speed of the object to zero. That is, the information processing device 20 stops the object. Thus, since the user can stop the object by pressing the mouse 10 with the weighting F greater than the threshold value Th, the user can operate the object with a more natural operation feeling.

Furthermore, since at least one of the scroll speed, the reproduction speed, and the moving speed of the object is included in the changing speed, the user can adjust these speeds with a natural operation feeling.

### 2. Second Embodiment

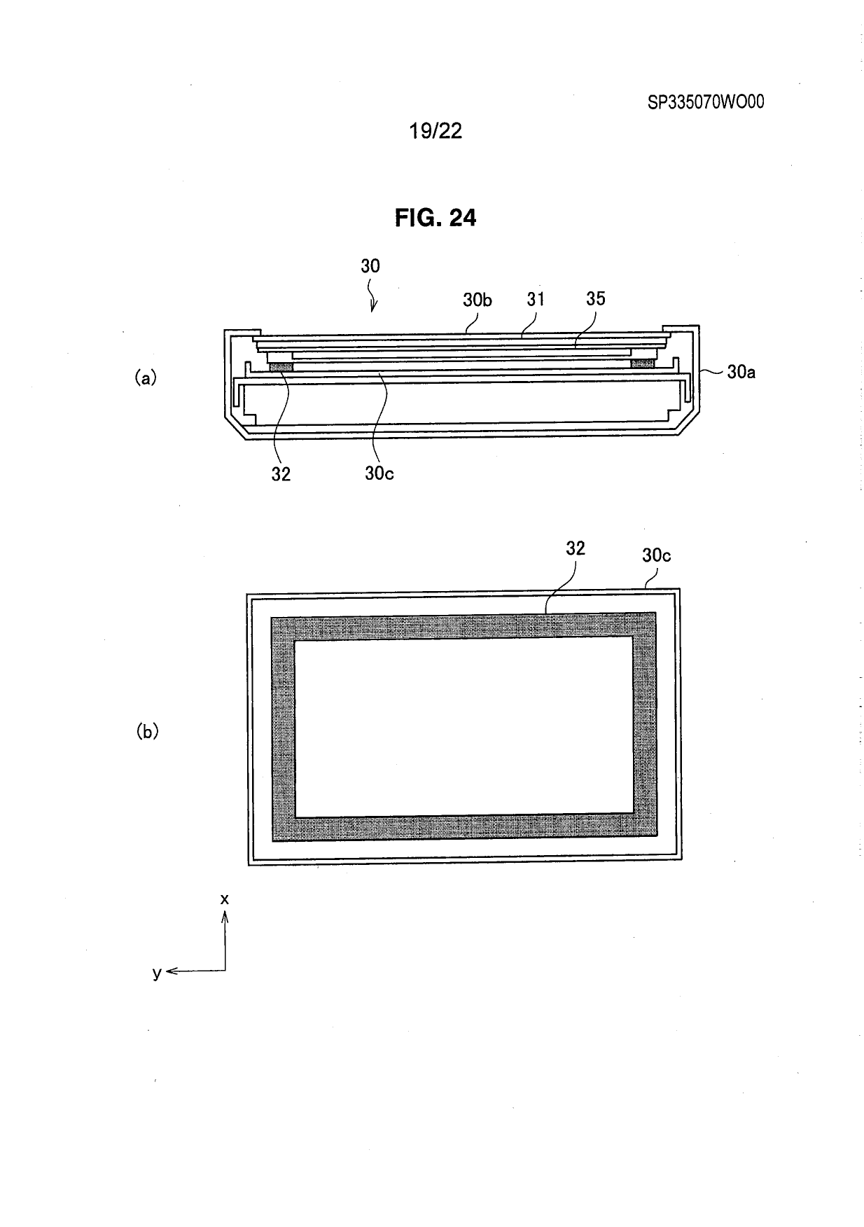

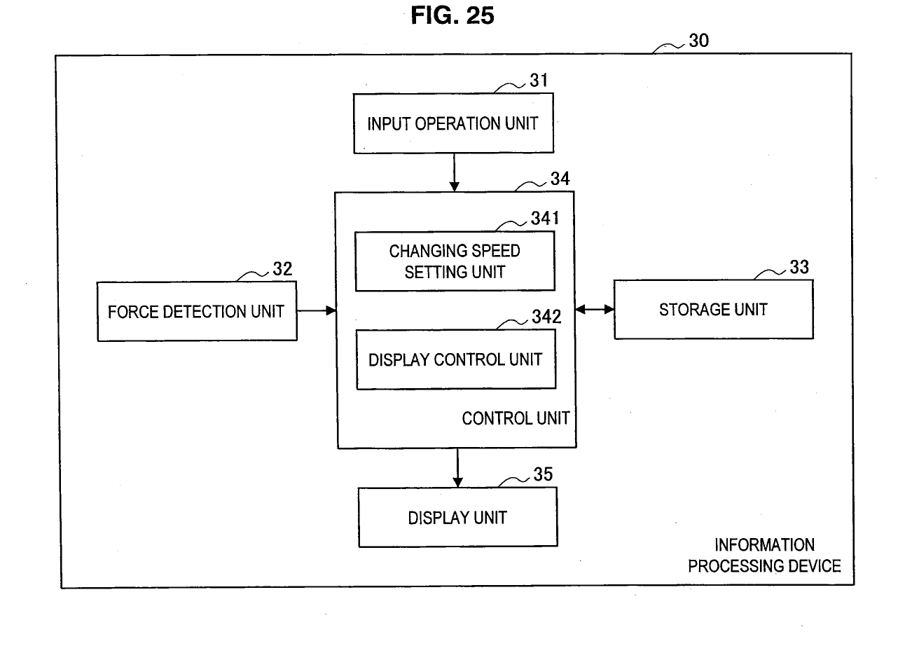

Next, a second embodiment will be described with reference to FIGS. 24 and 25. In the second embodiment, an information processing device 30 is a so-called smartphone or the like, and an input operation unit 31 is a touch panel inside the information processing device 30.

### 2-1. Configuration of Information Processing Device

Schematically, an information processing device 30 according to a second embodiment sets a changing speed of an object, based on a weight F acting on an input operation unit 31 being a touch panel, and changes the object at the set changing speed. Thus, first, the configuration of the information processing device 30 according to the second embodiment will be described with reference to FIGS. 24 and 25.

The information processing device 30 includes a housing 30a, a top plate 30b, a board 30c, an input operation unit 31, a force detection unit 32, a storage unit 33, a control unit 34, and a display unit 35. Incidentally, the information processing device 30 includes a hardware configuration, such as a CPU, a ROM, a RAM, and a communication device. A program necessary for realizing the input operation unit 31, the force detection unit 32, the storage unit 33, and the control unit 34, and the display unit 35 in the information processing device 30 is stored in the ROM. Therefore, each element of the information processing device 30 is realized by such a hardware configuration.

The housing portion 30a is a portion that covers a side and a bottom of the hardware configuration of the information processing device 30. The top plate 30b is a portion that covers a surface of the hardware configuration, specifically, a portion that covers a surface of the input operation unit 31 and the display unit 35. That is, the hardware configuration of the information processing device 30 is contained in a space formed by the housing portion 30a and the top plate 30b.

The board 30c is disposed more inside than the display unit 35. Also, the board 30c is parallel to the display unit 35, and a space is formed between the board 30c and the display unit 35. Also, the force detection unit 32 having a rectangular shape, and a wiring for providing the control unit 34 with information from the force detection unit 32 are disposed on the surface of the board 30c.

The input operation unit 31 is a so-called touch panel, and is disposed inside the top plate 30b. xy-axes are set in the input operation unit 31. As illustrated in FIG. 24(b), x-axis is a straight line extending in a direction perpendicular to a length direction of the input operation unit 31, and y-axis is a straight line extending in the length direction of the input operation unit 31. A positive x-axis direction is an upper direction in FIG. 24(b), and a positive y-axis direction is a left direction in FIG. 24(b). The xy-axes and the positive direction of each axis may be set to other contents. For example, in a case where the user performs a flick operation on the input operation unit 31, the input operation unit 31 detects a flick operation speed. Herein, the flick operation is an operation that slides a finger in a state in which the input operation unit 31 is touched with the finger. Specifically, the input operation unit 31 detects an x component and a y component of the flick operation speed. The input operation unit 31 generates moving speed information related to the detected flick operation speed, and outputs the moving speed information to the control unit 34.

The force detection unit 32 is a sensor that detects a pressing force (weighting) F by the user. The configuration of the force detection unit 32 is not particularly limited as long as it can detect the weighting by the user. Examples of the force detection unit 32 include an electrostatic capacitance type sensor, a resistance type sensor, and a strain gauge sensor. However, in a case where the force detection unit 32 is an electrostatic capacitance type sensor, it is suitable for the information processing device 30 because the output from the input operation unit 31 and the output from the force detection unit 32 can be handled by the same controller.

The storage unit 33 is similar to the storage unit 22 according to the first embodiment. The control unit 34 controls the respective elements of the information processing device 30, and also functions as a changing speed setting unit 341 and a display control unit 342. The changing speed setting unit 341 and the display control unit 342 are similar to the changing speed setting unit 231 and the display control unit 232 according to the first embodiment. The display unit 35 is disposed inside the input operation unit 31, and the force detection unit 32 is connected to an outer peripheral portion of the display unit 35. The display unit 35 displays various objects under the control of the display control unit 342.

### 2-2. Processing by Information Processing Device

The processing of the information processing device 30 is similar to the processing by the information processing device 20 according to the first embodiment. However, in the second embodiment, the user performs the flick operation instead of the drag operation.

According to the second embodiment, the same effect as that of the first embodiment can be obtained. Furthermore, in the second embodiment, since the user performs the operations through the touch panel, a more intuitive operation feeling can be obtained.

### 2-3. Modification

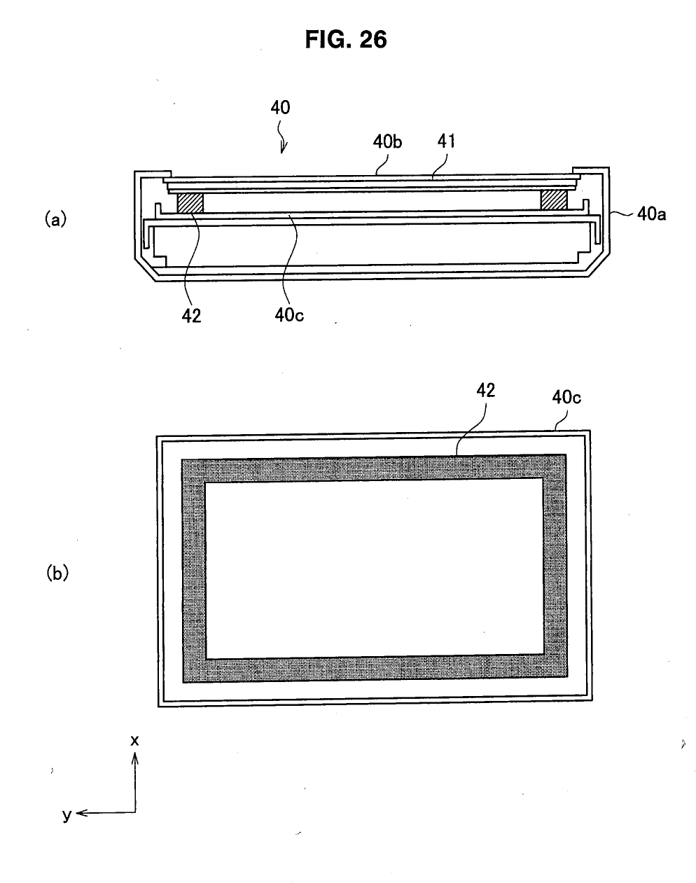

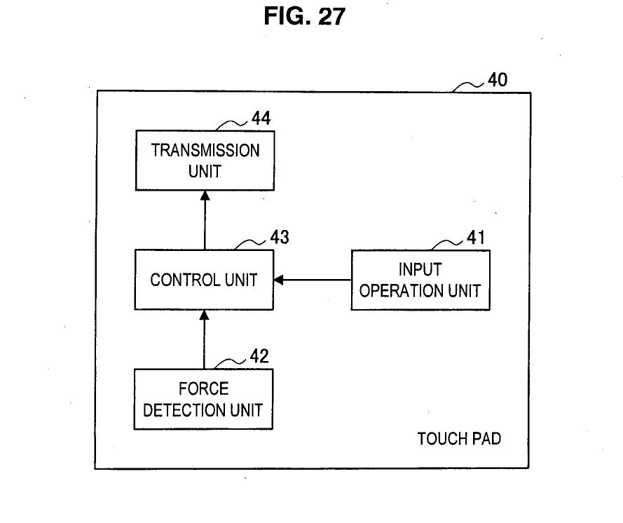

Next, a modification of the second embodiment will be described with reference to FIGS. 26 and 27. In this modification, as illustrated in FIGS. 26 and 27, a force detection unit 42 is provided in a touch pad 40. Also, the touch pad 40 can communicate with the information processing device 20 according to the first embodiment.

Specifically, the touch pad 40 includes a housing 40a, a top plate 40b, a board 40c, an input operation unit 41, a force detection unit 42, a control unit 43, and a transmission unit 44. Incidentally, the touch pad 40 includes a hardware configuration, such as a CPU, a ROM, a RAM, and a communication device. A program necessary for realizing the input operation unit 41, the force detection unit 42, the control unit 43, and the transmission unit 44 in the touch pad 40 is stored in the ROM. Therefore, each element of the touch pad 40 is realized by such a hardware configuration.

The housing portion 40a is a portion that covers a side and a bottom of the hardware configuration of the touch pad 40. The top plate 40b is a portion that covers a surface of the hardware configuration, specifically, a portion that covers a surface of the input operation unit 41. That is, the hardware configuration of the touch pad 40 is contained in a space formed by the housing portion 40a and the top plate 40b.

The board 40c is disposed more inside than the input operation unit 41. Also, the board 40c is parallel to the input operation unit 41, and a space is formed between the board 40c and the input operation unit 41. Also, the force detection unit 42 having a rectangular shape, and a wiring for providing the control unit 43 with information from the force detection unit 42 are disposed on the surface of the board 40c.

The input operation unit 41 is similar to the above-described input operation unit 31, and is disposed inside the top plate 40b. The force detection unit 42 is a sensor that detects a pressing force (weighting) F by the user, and is similar to the above-described force detection unit 32. The control unit 34 controls each element of the touch pad 40, and also generates touch pad operation information, including moving speed information provided from the input operation unit 41 and weighting information provided from the force detection unit, and outputs the touch pad operation information to the transmission unit 44. The transmission unit 44 can perform wireless communication with the information processing device 20 according to the first embodiment, and transmits the touch pad operation information to the information processing device 20. That is, the touch pad 40 is a so-called wireless touch pad, but may be connected to the information processing device 20 through a cable. The information processing device 20 performs the same processing as that of the first embodiment, based on the touch pad operation information. That is, the information processing device 20 performs the same processing as that of the first embodiment, based on the flick operation.

The preferred embodiments of the present disclosure have been described above with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

Additionally, the present technology may also be configured as below.

(1)

An information processing device including:

a changing speed setting unit that sets a changing speed of an object displayed on a display unit, based on a weighting to an input operation unit capable of inputting operation information related to a changing direction of the object; and

a display control unit that changes the object at the changing speed.

(2)

The information processing device according to (1),

wherein the input operation unit is capable of inputting a reference changing speed, which is a reference value of the changing speed, and

wherein the changing speed setting unit sets the changing speed based on the reference changing speed and the weighting.

(3)

The information processing device according to (2),

wherein, as the weighting is increased, the changing speed setting unit sets the changing speed to a value closer to the reference changing speed.

(4)

The information processing device according to (3),

wherein, when the weighting is greater than a predetermined value, the changing speed setting unit matches the changing speed of the object with the reference changing speed.

(5)

The information processing device according to (1),

wherein, as the weighting is increased, the changing speed setting unit sets the changing speed of the object to a smaller value.

(6)

The information processing device according to (5),

wherein, when the weighting is greater than a predetermined value, the changing speed setting unit sets the changing speed of the object to zero.

(7)

The information processing device according to any one of (1) to (6),

wherein the changing speed includes at least one of a scroll speed, an enlargement/reduction speed, a reproduction speed, and a moving speed of the object.

(8)

An information processing method including:

setting a changing speed of an object displayed on a display unit, based on a weighting to an input operation unit capable of inputting a changing direction of the object; and

changing the object at the changing speed.

(9)

A program for causing a computer to achieve:

a changing speed setting function of setting a changing speed of an object displayed on a display unit, based on a weighting to an input operation unit capable of inputting a changing direction of the object; and

a display control function of changing the object at the changing speed.

(10)

The program according to (9),

wherein the input operation unit is capable of inputting a reference changing speed, which is a reference value of the changing speed, and

wherein the changing speed setting function sets the changing speed based on the reference changing speed and the weighting.

(11)

The program according to (10),

wherein, as the weighting is increased, the changing speed setting function sets the changing speed to a value closer to the reference changing speed.

(12)

The program according to (11),

wherein, when the weighting is greater than a predetermined value, the changing speed setting function matches the changing speed with the reference changing speed.

(13)

The program according to (9),

wherein, as the weighting is increased, the changing speed setting function sets the changing speed to a smaller value.

(14)

The program according to (13),

wherein, when the weighting is greater than a predetermined value, the changing speed setting function sets the changing speed to zero.

(15)

The program according to any one of (1) to (14),

wherein the changing speed includes at least one of a scroll speed, an enlargement reduction speed, a reproduction speed, and a moving speed of the object.

### REFERENCE SIGNS LIST

10 mouse
11 click operation unit
12 xy movement detection unit
13 force detection unit
14 control unit
15 transmission unit
20 information processing device
21 reception unit
22 storage unit
23 control unit
231 changing speed setting unit
232 display control unit
24 display unit
30 information processing device
31 input operation unit
32 force detection unit
33 storage unit
34 control unit
341 changing speed setting unit
342 display control unit
35 display unit

1. An information processing device comprising:
a changing speed setting unit that sets a changing speed of an object displayed on a display unit, based on a weighting to an input operation unit capable of inputting operation information related to a changing direction of the object; and
a display control unit that changes the object at the changing speed.

2. The information processing device according to claim 1,
wherein the input operation unit is capable of inputting a reference changing speed, which is a reference value of the changing speed, and
wherein the changing speed setting unit sets the changing speed based on the reference changing speed and the weighting.

3. The information processing device according to claim 2,
wherein, as the weighting is increased, the changing speed setting unit sets the changing speed to a value closer to the reference changing speed.

4. The information processing device according to claim 3,
wherein, when the weighting is greater than a predetermined value, the changing speed setting unit matches the changing speed of the object with the reference changing speed.

5. The information processing device according to claim 1,
wherein, as the weighting is increased, the changing speed setting unit sets the changing speed of the object to a smaller value.

6. The information processing device according to claim 5,
wherein, when the weighting is greater than a predetermined value, the changing speed setting unit sets the changing speed of the object to zero.

7. The information processing device according to claim 1,
wherein the changing speed comprises at least one of a scroll speed, an enlargement reduction speed, a reproduction speed, and a moving speed of the object.

8. An information processing method comprising:
setting a changing speed of an object displayed on a display unit, based on a weighting to an input operation unit capable of inputting a changing direction of the object; and
changing the object at the changing speed.

9. A program for causing a computer to achieve:
a changing speed setting function of setting a changing speed of an object displayed on a display unit, based on a weighting to an input operation unit capable of inputting a changing direction of the object; and
a display control function of changing the object at the changing speed.

10. The program according to claim 9,
wherein the input operation unit is capable of inputting a reference changing speed, which is a reference value of the changing speed, and
wherein the changing speed setting function sets the changing speed based on the reference changing speed and the weighting.

11. The program according to claim 10,
wherein, as the weighting is increased, the changing speed setting function sets the changing speed to a value closer to the reference changing speed.

12. The program according to claim 11,
wherein, when the weighting is greater than a predetermined value, the changing speed setting function matches the changing speed with the reference changing speed.

13. The program according to claim 9,
wherein, as the weighting is increased, the changing speed setting function sets the changing speed to a smaller value.

14. The program according to claim 13,
wherein, when the weighting is greater than a predetermined value, the changing speed setting function sets the changing speed to zero.

15. The program according to claim 9,
wherein the changing speed comprises at least one of a scroll speed, an enlargement/reduction speed, a reproduction speed, and a moving speed of the object.
